(19) United States
(12) Patent Application Publication
(10) Pub. No.: US 2008/0268874 A1
(43) Pub. Date: Oct. 30, 2008

(54) Cellular phone with special GPS functions

(76) Inventor: David Pizzi, Pfaeffikon SZ (CH)

Correspondence Address: David Pizzi, Sonnenhof 20, Pfaeffikon SZ, 8808, omitted

(21) Appl. No.: 12/110,302

(22) Filed: Apr. 26, 2008

Related U.S. Application Data
(60) Provisional application No. 60/914,627, filed on Apr. 27, 2007.

(51) Int. Cl. H04Q 7/32

(52) U.S. Cl. 455/456.6

(57) ABSTRACT

Mobile cellular phone with integrated positioning system and archiving in this way advanced functions based on its location and navigation capabilities. Based on its location and internal consumption statistics can notify the user if the expected battery-level won't be enough for the next period of time outside such location. Based on its location can automatically send predefined or programmed messages (SMS) to defined users. In its internal call log register keeps also the location where the call has been received or done, and can display this back to the user on request. Can encode navigation instructions to the user when walking through mechanic vibration signals.

### CROSS REFERENCE TO RELATED APPLICATIONS

Provisional U.S. Patent No. 60/914,627 (EFS ID 1725702), filed Apr. 27, 2007, and titled “Cellular phone”.

The entire content of the above listed provisional US patent application is hereby incorporated by reference.

### BACKGROUND OF THE INVENTION

1. Field of the Invention

This invention relates generally to mobile and cellular phones and terminals with an internal processor and GPS sensor.

Cellular phone usage in the United States has reached a critical mass, with almost two-thirds of American adults now owning a cellular phone, according to a recent study from Scarborough Research. This represents a 29% growth rate of cellular phone ownership over the past two years. This growth is likely to continue, since 9% of American adults plan to purchase a cell phone in the next year.

Mobile phones are becoming objects everyone has and everyone has always with himself, just as wristwatches. They are used very frequently during the whole day for many functions, from phoning to agenda, from sending and receiving Emails to music players. Also during night they are kept close to the user and many times work even as alarm clocks.

The invention discloses an improved cellular phone with novelty functionalities related to its localization component (GPS or equivalent).

2. Description of Related Art

Related Art Relative to Battery Remaining Capacity Control.

U.S. Pat. No. 7,171,186 (Filing date Jul. 14, 2003/Miyachi, Ryoko; Mikami, Tsutomu) discloses a mobile phone that indicates remaining capacity of the battery through checking of the voltage and also correction of battery deterioration, outside temperature.

Related Art Relative to GPS Improvements for Use on Cellular Phones.

Patent application US20070037605 (Filing date Oct. 18, 2006/Logan, James) discloses a mobile phone whose profile (ring-tone) is controlled by its absolute position (through GPS system) or relative to another object. Also time of the day, ambient light and other parameters may be considered to switch the correct profile.

Therefore, it would be advantageous to have some additional systems and methods to increment user friendliness and automation of many frequent operations on such device. Also to have additional and innovative functionalities on such device is desirable.

### BRIEF DESCRIPTION OF THE DRAWINGS

Accompanying figures are incorporated in and form part of the specification, serve to further illustrate various embodiments and to explain various principles and advantages all in accordance with the present invention.

FIG. 1 illustrates an exemplary embodiment of the disclosed cellular phone with a GPS sensor.

FIG. 2 shows a hypothetical display to configure the battery charge reminder.

FIG. 3 shows a hypothetical display to configure the system to send automatically SMS at a specific location.

FIG. 4 shows a hypothetical display showing the call log register including the location where the incoming call was received.

FIG. 5 shows a hypothetical display to configure the vibration based navigation.

### SUMMARY OF THE INVENTION AND DETAILED DESCRIPTION OF THE PREFERRED EMBODIMENT

The innovative improvements object of this invention are disclosed relatively to a “mobile phone”. This can be either a “cellular phone” or a “wireless phone” connected to a base station. Such phone including an integrated location sensor based on radio signals. This can be one based on the GPS or GALILEO standards/protocols. It must be understood that object of this invention is not the specific location standard used, which may vary from period to period and country to country, but the use of this as integrated part of a cellular phone providing some advanced improvements.

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings.

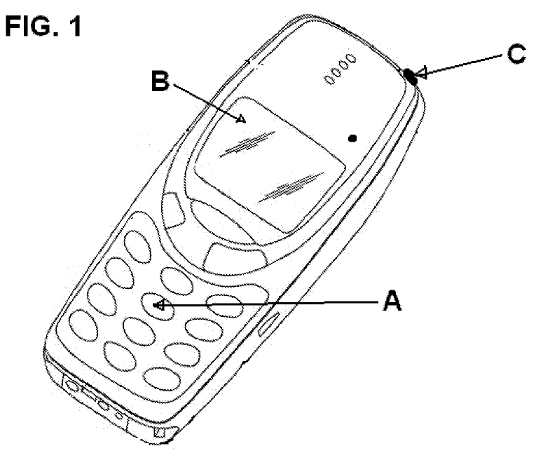

Referring to FIG. 1, an exemplary cellular phone device with GPS sensor is shown. The communication device, for example, is a cellular telephone (as illustrated), but for many of the disclosed innovations it could be any type of mobile communication device with a location sensor, for example a cellular phone, a PDA, a portable communication station, etc.

FIG. 1 shows a typical cellular phone. [A] is the mechanic keyboard. [B] is the display of the phone, used to give visual feedback to the user and allows him to navigate through the functions of the device and configure it. [C] is the location sensor integrated inside the cellular phone.

The handheld device has a key-based user input interface to control its functionalities ([G] of FIG. 1). In the following description, the term “keypad” and “key” refers to any user input interface, such as a keypad or any function key (push-down, switch, rotation-key, touch-pad, touch-screen, etc.).

The handheld device has a user output interface to inform him about the different functions, state, etc. In the following description, the term “display” refers to any user visual output interface, such as a led display, LCD, OLED, active or passive matrix display, etc.

A problem many users have with handheld electronic devices and mobile phones in particular is that they run out of battery during the day and cannot use anymore their handheld device, since most of the times no battery charger is present outside home. Current art low-battery reminders in fact are not very useful, since they begin reminding the user or long before battery empty status, sometimes also during night, or too short before they run out, with the risk they are run out during the day without any possibility to charge it. They also don't take into account different consumer profiles and phone usages, so a low-level for frequent user A may not be a low-level for user B that uses the phone only on a sporadic base. A more smart and reliable system is therefore absolutely required.

An internal computer-based system of the disclosed handheld device calculates and keeps in its internal database the average and high percentile (e.g. 95%) of battery consumption for current user. This can be done considering only last X days, considering whole device life and/or giving different weights to most recent days. Another software-based system that compares current level with the database average value then reminds at a defined/configurable time, for example in the morning or just after ringing of the alarm clock, the user that current level won't be enough for the coming whole day. This will allow the user, for example, to put it in recharge while doing his morning tasks (bathing, breakfast, etc.) and have it recharged when leaving home.

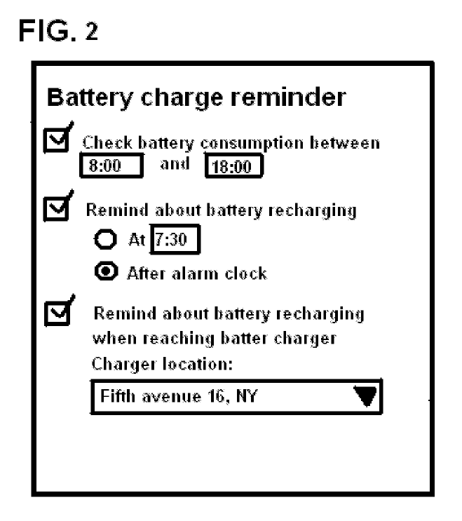

FIG. 2 shows a sample configuration display to set-up the “battery charge reminder”. This allows configuring in the first option the time interval to consider when monitoring battery consumption. The consumption during this interval is then recorded in an internal database for calculating statistical values like average consumption, weighted average consumption and/or consumption with a given percentile (e.g. 95%). Another option allows configuring when the user wants to be reminded that the battery won't last for the whole day. This may be a specific time (e.g. 7:30 am) or a specific event (e.g. an alarm clock). Last option, in case the device includes also a localization system, allows then configuring the device to remind only when reaching a specific location, such location being the one where the battery charger is available (e.g. home address). Of course it must be understood that this display is just a sample and many variation can be implemented without exiting the scope of current invention.

In the disclosed phone it's also possible to program a list of automatically sent messages (SMS or Emails) when the phone is in a defined location. This will allow, for example, informing automatically other persons that you are in a given place. Another use is to automatically switch on heating/cooling systems (current art includes heating/cooling systems that may be controlled remotely via SMS) before reaching home. In fact systems based solely on the time an SMS is sent may not be as reliable and precise as the ones based also on the location. For example, if the user wants to switch automatically the home heater on before being at home at evening, it is more accurate to program the system to send an SMS automatically at a defined location on the way back home as send it automatically at a defined time, with the risk to miss the scope when coming back earlier or consume unnecessary power when having a delay.

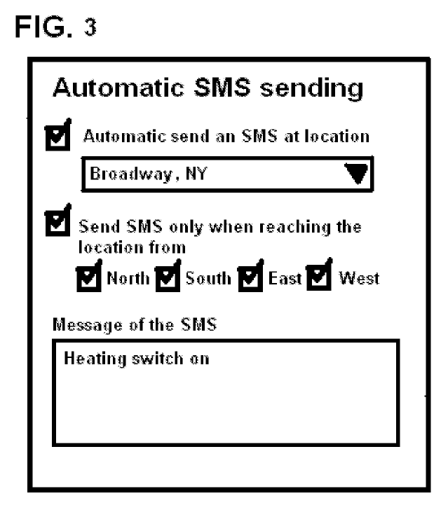

FIG. 3 shows a sample configuration display to configure the automatic SMS sending at a specific location. Together with a trigger location it's also possible to define a direction of provenience that activates the sending of the SMS and the text to be sent. Of course it must be understood that this display is just a sample and many slight variation can be implemented without exiting the scope of current invention. Also more instances of automatic SMS may be configured.

Outgoing and incoming call logs are kept in an internal register/database. The user may view such register, and calls selected and recalled back. An innovative feature of disclosed phone is that it logs, together with the phone number and date/time, also the location of the phone at the time of the call event. It is known that user usually, in particular when receiving calls, associates the event more strongly with the location as with other parameters as the time. This allows finding out received or missed calls, in particular if happened long ago, more easily than current art systems logging only the time of the call. Grouping the calls in the register by location is also possible.

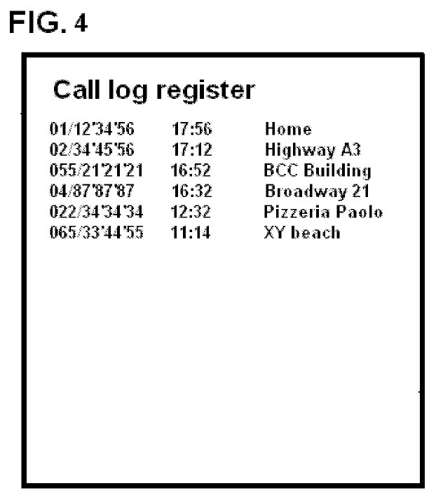

FIG. 4 shows an hypothetical display the call log displaying also the location of the call. Such location is looked up from the coordinates sensed by the localization system (GPS, GALILEO or equivalent) on an internal database of geographic charts. The displayed information may be then the name of a street, a village, a particular building, a park, etc.

The integrated localization and navigation system allows to use the disclosed mobile phone also for navigation, both in cars as well as when walking around. Navigation instructions are communicated through visual (geographic maps) and/or acoustic signals (voice instructions). There are anyway situations when such methods are not desired. One such situation is while phoning, where the phone is held at the user ear and so the display not visible and acoustic messages may be disturbing the phone call. Another situation is when driving a motorcycle. When such a situation is detected by mean of sensors or enabled by the user, navigation information is encoded through vibration signals, changing in rhythm and/or frequency and/or intensity depending on the instruction. So, for example, a single short vibration may mean “turn left”, while a longer one at a higher frequency “turn right”.

It must be understood that the used vibration patterns for the different instructions may vary and also be configurable by the user. Also the intensity may be configurable and associated with a profile. So, for example, while riding a motorcycle it is desired to have a stronger vibration signal as when phoning.

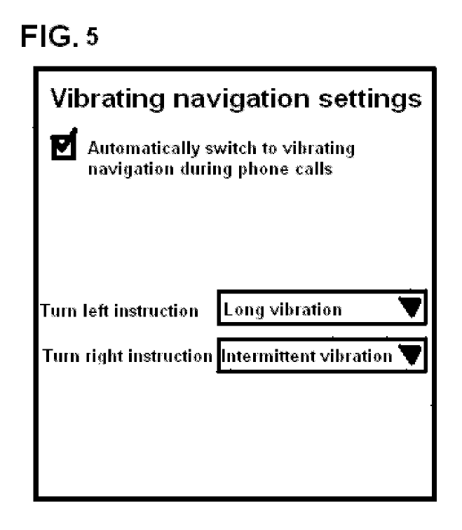

FIG. 5 shows an hypothetical screen to configure the “vibrating navigation settings”. A checkbox allows enabling it automatically when a phone call is ongoing and the phone was in navigation mode before. Navigation instruction won't be stopped, but just switched to vibration instructions.

The description of the present invention has been presented for purposes of illustration and description but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

This disclosure is intended to explain how to fashion and use various embodiments in accordance with the invention rather than to limit the true, intended, and fair scope and spirit thereof. The above description is not intended to be exhaustive or to limit the invention to the precise form disclosed. Modifications or variations are possible in light of the above teachings. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A mobile phone with integrated location sensor, an internal battery and an external battery charger, the mobile phone being used outside the battery charger region for longer periods of time (“standalone-period”), recording on an internal register common battery consumptions during such “standalone-period” periods and trigger special events when inside/close to the battery charger location/region and next calculated/expected “standalone-period” period will be low (“level-insufficient”).

2. The method of claim 1, wherein the location system is based on the GPS and/or GALILEO technology.

3. The method of claim 1, wherein the special event triggered about “level-insufficient” for next “standalone-period” is acoustic, visual and/or a combination of both.

4. The method of claim 1, wherein the special event triggered about “level-insufficient” for next “standalone-period” is shown at specific, user configurable, times and/or events.

5. A mobile phone with integrated location sensor that can be configured to send automatically messages when reaching or crossing a specific location/region.

6. The method of claim 5, wherein the message protocol is SMS (Short Message Service).

7. The method of claim 5, wherein the message protocol is based on WiFi.

8. The method of claim 5, wherein together with the location also the provenience and direction is considered before the message is sent.

9. The method of claim 5, wherein together with the location also the speed is considered before the message is sent.

10. The method of claim 5, wherein the message is a user-defined text.

11. The method of claim 5, wherein a confirmation by the user is required before the message is sent.

12. A mobile phone with integrated location sensor which records in its internal call-register the location where the a phone call has been done or received.

13. The method of claim 12, wherein the saved location is the building name, street name, city name, region name.

14. The method of claim 12, wherein the saved location is displayed together with other call information as date/time of call, person calling and similar.

15. A mobile phone with integrated navigation system which encodes navigation instructions through mechanic vibration signals.

16. The method of claim 15, wherein such encoding method is automatically activated when the phone is close to the user ear.

17. The method of claim 15, wherein the vibration signals vary in rhythm.

18. The method of claim 15, wherein the vibration signals vary in frequency.

19. The method of claim 15, wherein the vibration signals vary in intensity.

20. The method of claim 15, wherein the encoded instruction is a “turn left” message.

21. The method of claim 15, wherein the encoded instruction is a “turn right” message.

22. The method of claim 15, wherein the encoded instruction is a “stop” message.
